(19) United States
(12) Patent Application Publication
(10) Pub. No.: US 2025/0226596 A1
(43) Pub. Date: Jul. 10, 2025

(54) Multi-Band Antenna Arrays Having Antenna Elements Arrayed In-Phase

(71) Applicant: Mimosa Networks, Inc., Santa Clara, CA (US)

(72) Inventor: Brian L. Hinman, Los Gatos, CA (US)

(21) Appl. No.: 19/065,985

(22) Filed: Feb. 27, 2025

Related U.S. Application Data
(62) Division of application No. 17/532,946, filed on Nov. 22, 2021.
Application No. 17/532,946 is a continuation of application No. 15/658,324, filed on Jul. 24, 2017, now Pat. No. 11,251,539.
(60) Provisional application No. 62/368,946, filed on Jul. 29, 2016.

(51) Int. Cl. H01Q 21/28; H01Q 1/00; H01Q 1/22; H01Q 1/24; H01Q 1/48; H01Q 5/30; H01Q 5/40; H01Q 9/04; H01Q 21/08; H01Q 21/20; H01Q 21/24; H04B 1/38; H04B 7/0413; H04B 7/06

(52) U.S. Cl. CPC H01Q 21/28; H01Q 1/007; H01Q 1/2291; H01Q 1/48; H01Q 5/30; H01Q 5/40; H01Q 9/0407; H01Q 21/08; H01Q 21/205; H01Q 21/24; H01Q 1/246; H04B 1/38; H04B 7/0413; H04B 7/0617

(57) ABSTRACT

Multi-band antenna arrays and methods of use are provided herein. An example device includes a tubular body comprising a plurality of ground plane substrates that are arranged into a geometrical configuration. Antenna arrays are associated with the plurality of ground plane substrates. The antenna elements of the antenna arrays are arrayed together in-phase so that an electrical downtilt of an elevation beam-width is fixed relative to a substantially horizontal reference plane. The device also includes two or more radios connected to the antenna arrays on the plurality of ground plane substrates via a feed network.

### CROSS REFERENCE TO RELATED APPLICATIONS

This application is a divisional of U.S. application Ser. No. 17/532,946, filed on Nov. 22, 2021, which is a continuation application of U.S. application Ser. No. 15/658,324, filed on Jul. 24, 2017, now U.S. Pat. No. 11,251,539, issued on Feb. 15, 2022, which claims the benefit and priority of U.S. Provisional Application Ser. No. 62/368,946, filed on Jul. 29, 2016, the disclosures of which are hereby incorporated by reference herein including all references and appendices cited therein.

### FIELD OF THE INVENTION

The present disclosure pertains to multi-band antenna arrays, and more specifically, but not by limitation to multi-band antenna arrays that can be incorporated into an access point, comprising groups of antennas vertically arranged onto a multi-faceted chassis, while providing 360-degree coverage and reduction in an elevation beam width of the multi-band antenna array.

### SUMMARY

In one aspect, the present disclosure is directed to a multi-band antenna array, comprising: (a) a tubular body comprised of a plurality of ground plane substrates which have been arranged into a geometrical configuration; (b) antenna arrays associated with the plurality of ground plane substrates, antenna elements of the antenna arrays being arrayed together in-phase so that an electrical downtilt of an elevation beam-width is fixed relative to a substantially horizontal reference plane; and (c) two or more radios connected to the antenna arrays on the plurality of ground plane substrates via a feed network.

In another aspect, the present disclosure is directed to a method of configuring a multi-band antenna array in-phase, comprising: (a) arranging vertical surfaces in a geometric configuration, each of the vertical surfaces comprising antenna arrays aligned along the vertical surfaces, wherein antenna elements of the antenna arrays are arrayed together in-phase so that an electrical downtilt of an elevation beam-width is fixed relative to a substantially horizontal reference plane; and (b) connecting two or more radios to the antenna arrays on the vertical surfaces via a feed network, the vertical surfaces comprising 5 GHz antenna arrays and 2.4 GHz antenna arrays, the 2.4 GHz antenna arrays being placed in alternating fashion between the 5 GHz antenna arrays.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a perspective view of an example multi-band antenna array device 100, constructed in accordance with the present disclosure.

FIG. 2 is a front elevational view of the example multi-band antenna array device of FIG. 1.

FIG. 3 is a top down cross-sectional view of the example multi-band antenna array device.

FIG. 4 is a perspective view of the example multi-band antenna array device, illustrating vertically arranged antenna elements.

FIG. 5 is a schematic diagram of an example use case illustrating deployment of an example multi-band antenna array device and different elevation beam widths.

FIG. 6 is a top down cross-sectional view of another example multi-band antenna array device.

FIG. 7 is a top down cross-sectional view of yet another example multi-band antenna array device.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

There is an increasing trend to deploy Wi-Fi access points that operate concurrently on two bands, typically 2.4 GHz and 5 GHz. Operating on two bands increases the throughput and number of clients supported by an access point. It also creates the possibility of offering hotspot service on one band (e.g. 2.4 GHz), while offering fixed service on the other band (e.g. 5 GHZ). Improving the range for which access points can communicate with low-gain clients, such as mobile devices and tablets, requires a combination of physical and processed antenna gain. This is becoming more important as Wi-Fi moves from predominantly indoor deployments to outdoor deployments, blanketing entire cities with Wi-Fi connectivity. Physical antenna gain is often achieved by arraying a set of antenna elements together, increasing the directionality of the array. The tradeoff of employing antenna arrays is limiting the directionality to a more narrow angular range. As a general observation, humans tend to live and work within a narrow elevation angle relative to the surface of the earth. Thus, it's often practical to create vertical arrays of antenna elements, which has the effect of increasing the gain of the array, while reducing the elevation beam-width. Cellular antenna panels, as an example, have been designed as arrays of vertical elements for many years.

Generally speaking, indoor dual-band Wi-Fi access points today use individual elements connected to a multiplicity of chains on a MIMO radio. 3×3 and 4×4 MIMO chipsets are quite common today. A typical dual-band access point would have three antenna elements connected to the three chains of a 3×3 MIMO radio at 2.4 GHZ, and another three antenna elements connected to the three chains of another 3×3 MIMO radio at 5 GHz. For products not having external “stick” antennas, manufacturers have tended to solder bent metal antenna elements into a shared printed circuit board, producing an access point with a low vertical profile. While attractive when mounted on a ceiling, for example, such designs inherently have low antenna gain, as the effective projected surface area is not maximized in the direction of transmission and reception. It's generally recognized that access points with external antennas perform better. The reason is that each antenna typically has 5 dBi of gain in the horizontal plane when oriented vertically, and MIMO radios employ beam-forming to electronically array the antennas to improve the processed antenna gain through real-time adaption. Access points with external stick antennas are generally considered less attractive than access points with antennas integrated with the electronics though. Ironically, the superior performance of access points with external antennas is defeated by installing the devices in out-of-sight locations, such as in a cabinet.

Outdoor Wi-Fi is less popular than indoor Wi-Fi today. Typical use cases include Wi-Fi and Wi-Fi-derived radios for fixed access, and Wi-Fi access points in large venue and hospitality applications. In the latter case, the products deployed are often weatherized versions of those found in indoor applications.

While weatherizing an indoor access point for outdoor use is not ideal from an antenna gain perspective, Wi-Fi access point vendors have not considered the market potential to be large enough to warrant an outdoor-optimized design. In the case of fixed access, however, manufacturers have had to address the antenna gain issue; else the link budget would not be sufficient to maintain connectivity over long distances. For point-to-point fixed wireless links, parabolic antennas have become the norm, increasing the antenna gain in a “pencil beam” at both ends of the link to overcome the free-space-path-loss. For point-to-multipoint fixed wireless applications, manufacturers have followed the model of the cellular industry.

“Sector antennas” are typically formed using a vertical array of antenna elements placed over a metallic ground plane. The resulting antennas, often using two polarizations, have a relatively narrow elevation beam-width, while maintaining the azimuthal beam-width as 60, 90, or 120 degrees, typically.

Recent access points have become available that integrate four arrays operating at 5 GHz, with each of the four arrays covering a different 90-degree quadrant, creating an effective 360-degree pickup pattern. Operating a cluster of such arrays with a 4×4 MIMO radio means that one array plays a dominant role while communicating with a client in one direction, while another array plays a dominant role while communicating with another client in a different direction. Ignoring the arrays with little or no signal present allows the MIMO radio to take advantage of the antenna gain afforded by a single array covering a 90-degree angle.

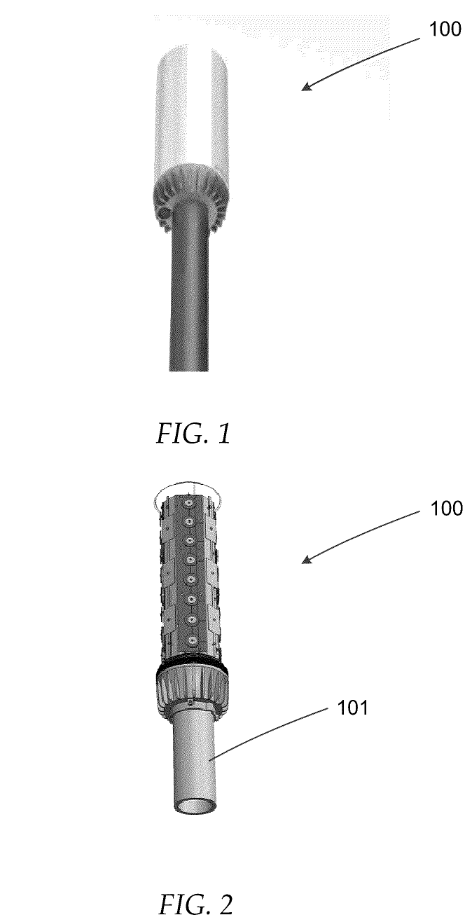

FIG. 1 is a perspective view of an example multi-band antenna array device 100 (multi-band access point) mounted on a support structure such as a mounting pole 101. FIG. 2 is a front elevation view of the multi-band antenna array device 100.

To create a multi-band access point with minimal cross-sectional area, capable of communicating with clients over 360 degrees, generally in the horizontal plane of the Earth, the multi-band antenna array device 100 comprises an array of eight antenna arrays, clustered vertically around an octagonal form. Each of the antenna arrays consists of individual antenna elements, arranged vertically, connected through a “corporate feed,” series feed, or combination thereof. The antenna elements may be single or dual-polarization, using linear (e.g. vertical/horizontal, or slant 45 degrees) or circular polarization techniques. The antenna elements are generally placed over a metallic ground plane, which has the effect of creating directivity, limiting the pattern to approximately 90 degrees in the azimuthal direction. Alternating faces of the cluster serve a particular band of operation. For example, if the array on a regular octagonal form pointing toward the North operates in the 2.4 GHz band, then the arrays pointing Northeast, Southeast, Southwest and Northwest would be dedicated to the 5 GHz band, while the North, East, South and West faces would serve the 2.4 GHz band.

The faces of the octagon need not have the same width, as the ground plane for a lower frequency band may need to be wider than the ground plane for the higher frequency band. Moreover, the angles between the arrays may not be separated by 45 degrees. In the extreme, the arrays of two different bands may share a common surface, forming a square form rather than an octagonal form. This is generally less desirable though, as the maximum diameter of the array will increase in a square form relative to an octagonal form.

For the case of an integrated access point, whereby the electronics and antenna cluster share a common enclosure, it will be desirable to mount the electronics inside the form of the octagonal structure, as this would otherwise be an empty volume. Cables would extend from the electronics board to each of the eight antenna arrays. The dual-band antenna array may support a total of eight chains, 12 chains, or 16 chains, depending upon the MIMO radio employed. Each array servicing a 90-degree azimuthal pattern can be either single or dual polarization. The combinations would be four chains on both bands (single polarization in each array), both permutations of four chains on one band and eight chains on the other band, and eight chains on both bands (dual polarization in each array).

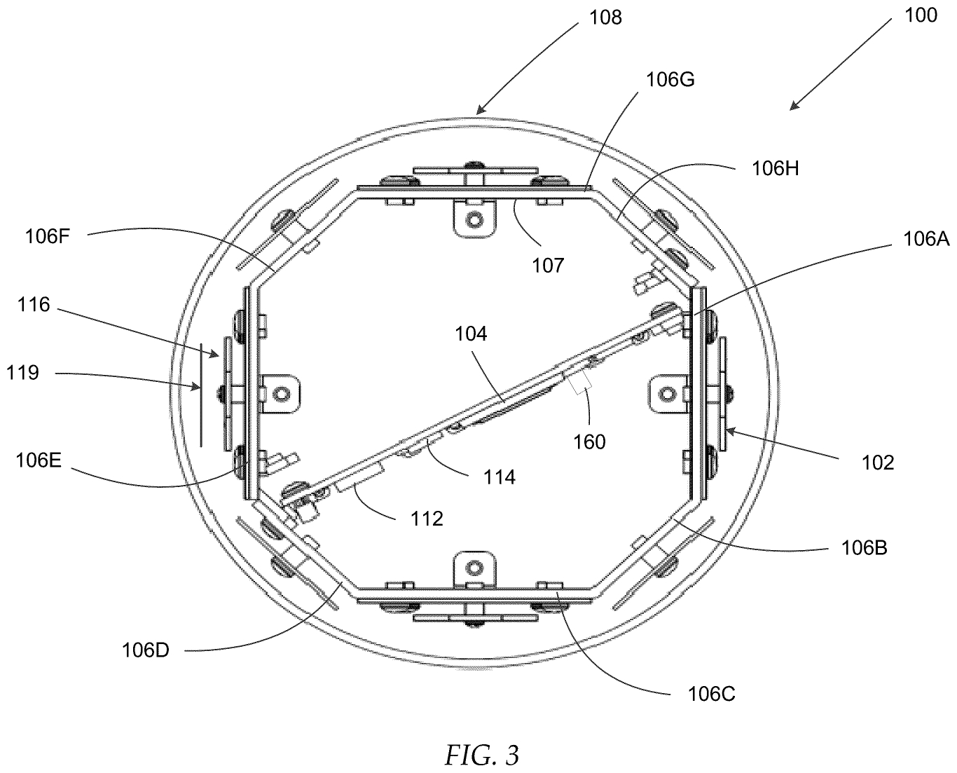

FIG. 3 is a cross-sectional view of the example multi-band antenna array device 100, constructed in accordance with the present disclosure. Namely, the multi-band antenna array device 100 illustrated in FIG. 3 comprises an octagonal grouping of antenna arrays 102 and radio board 104. The octagonal grouping of antenna arrays 102 is comprised of eight ground plane substrates 106A-H (referred to as ground plane surfaces or vertical surfaces in some examples) that are joined together to form a generally octagonal tubular member. To be sure, the octagonal grouping of antenna arrays 102 can have additional or fewer surfaces creating tubular members of varying cross sections such as decagon, square, pentagonal, or other polygonal shapes.

The ground plane substrates 106A-H are supported by (e.g., mounted on) a chassis 107 that can be constructed from any suitable material that would be known to one of ordinary skill in the art with the present disclosure before them.

In one or more embodiments, ground plane substrates 106A, 106C, 106E, and 106G are each associated with 5 GHz antennas and ground plane substrates 106B, 106D, 106F, and 106H are each associated with 2.4 GHz antennas. Each of the ground plane substrates has a thickness that can vary according to design requirements. The ground plane substrates are constructed from any suitable material that would be known to one of ordinary skill in the art with the present disclosure before them.

Additionally, the ground plane substrates 106A, 106C, 106E, and 106G comprise a first width and the ground plane substrates 106B, 106D, 106F, and 106H comprise a second width. In one embodiment the first width is greater than the second width. In another embodiment the first width and second width are substantially similar in size relative to one another.

The ground plane substrates 106A, 106C, 106E, and 106G are disposed alternatingly with the ground plane substrates 106B, 106D, 106F, and 106H. For example, ground plane substrate 106B is disposed between ground plane substrates 106A and 106C.

The ground plane substrates 106A, 106C, 106E, and 106G are disposed in parallel or perpendicularly to one another. For example, ground plane substrate 106A and ground plane substrate 106C are perpendicular to one another and ground plane substrates 106A and 106E are disposed parallel to one another.

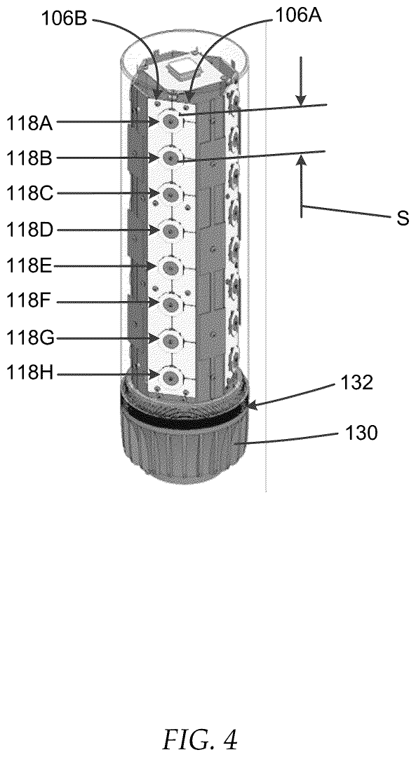

Each of the ground plane substrates 106A-H comprises antenna elements. Additional details regarding the antenna elements are described and illustrated with reference to FIG. 4.

The radio board 104 comprises one or more radios, such as radios 112 and 114. The radio board 104 is disposed within the octagonal grouping of antenna arrays 102, in one embodiment.

In one embodiment the radio 112 is a 5 GHz radio and the radio 114 is a 2.4 GHz antenna. The antennas associated with ground plane substrates 106A, 106C, 106E, and 106G are coupled to the 5 GHz radio 112 and the antennas associated with ground plane substrates 106B, 106D, 106F, and 106H are coupled to the 2.4 GHz radio 114. This octagonal configuration having at least eight ground plane substrates allows for 8×8 MIMO (multiple input multiple output) operation at 5 GHz when dual-polarization is used on four quadrants. Single polarization on each of the 2.4 GHz quadrants provides 4×4 MIMO operation.

The example multi-band antenna array device 100 comprises a shroud or housing 108 that surrounds the octagonal grouping of antenna arrays 102 and radio board 104.

The multi-band antenna array device 100 is series fed set of patch antennas, which results in reduced operating bandwidth because the phase is dependent upon the propagation time from one element to the next. In a corporate feed, a tree is formed that equalizes the time to each element, which eliminates a phase misalignment over frequency. In the 2.4 GHz Wi-Fi band, the total operating bandwidth is only 4% of a band center frequency, while in the 5 GHz band, a total operating bandwidth is 13% of the band center frequency. Consequently, corporate feeds are appropriate for the 5 GHz band, while either corporate or series feeds can be used for the 2.4 GHz band. The advantage of the series feed in this particular instance is that it occupies less ground plane width, allowing the overall octagonal form to be as small as possible.

A feed network 116 is located within the housing 108 and is electrically coupled to the radio board. The antenna elements of each of the ground plane substrates 106A-H are arrayed through the feed network 116 in such a way that the antenna gain of the antenna arrays is increased while the elevation beam-width produced by the antenna arrays is reduced. In some embodiments, the feed network 116 is spaced apart from surface 106F, although the feed network 116 can be positioned in other locations within the example multi-band antenna array device 100.

In one embodiment, the elements of the antennas are arrayed using a fixed network of interconnect. In one embodiment, the fixed network of interconnect comprises a corporate feed where the lines connecting the elements receive signals at approximately the same time. In another embodiment, the interconnect can comprise series alignment over 360 degrees, which results in a frequency dependent configuration.

Also, in some embodiments antenna elements can be configured in-phase. In general, a vertical array of elements is pointed perpendicularly to a reference plane, such as the horizon. When wire lengths interconnecting elements (such as in a corporate feed) are equal, there is in-phase alignment of signals received from near the horizon, which gives rise to constructive interference at a terminal end of the corporate feed.

The introduction of an electrical downtilt in the device reduces the constructive interference.

The example multi-band antenna array device 100 can also comprise a 5 GHz parasitic patch 119 that is disposed proximate to one of the 5 GHz surfaces, such as surface 106E. Parasitic elements are placed above a driven patch element, which is typically mounted on a low-loss substrate over a ground-plane. The parasitic elements improve the efficiency and bandwidth of a patch antenna. A suitable example of this arrangement is disclosed in U.S. Pat. No. 4,835,538, which is hereby incorporated by reference here in its entirety, including all references cited therein.

In FIG. 4 the example multi-band antenna array device 100 is illustrated with three surfaces, surface 106A, 106B, and 106C. The surfaces 106A and 106C each comprise a plurality of antenna elements, such as elements 118A-H. Surface 106A comprises antenna elements 118A-H. In one embodiment, adjacent ones of the elements 118A-H are spaced apart from one another to effectuate the elevation beam crushing features of the present disclosure, as described in greater detail infra.

The vertical orientation of elements 118A-H functions to increase antenna gain. A vertically arranged antenna array provides a benefit of crushing an elevation pattern of the multi-band antenna array device 100. For example, in a device with a single element, the single element will have an elevation beam width of approximately +/−45 degrees and an azimuth angle width of +/−45 degrees. The multi-band antenna array devices of the present disclosure comprise elements that are vertically arranged together and disposed in spaced apart relationship to one another. In one embodiment the spacing between adjacent antenna elements, such as spacing S between elements 118A and 118B, is approximately 0.8 of a lambda. Other spacings can be utilized in accordance with the present disclosure. In general, element-to-element spacing can vary between 0.7 and 0.85 lambda, depending upon the number of elements and designer discretion. Other spacings are likewise contemplated for use based on the desired antenna gain and/or desired elevation beam width.

In some embodiments, antenna elements are connected together in-phase such that the elevation beam width of this combination is reduced from +/−45 degrees to approximately +/−22.5 degrees. When a pair of two elements (four elements total on a vertical surface in some embodiments) are vertically arranged together so that adjacent elements are spaced apart from one another and connected together in-phase (e.g., corporate feed), the elevation beam width of this combination is reduced from +/−22.5 degrees to approximately +/−11.25 degrees. Again, this compression or crushing of the elevation beam width allows the device to have a 360 degree coverage area but broadcast along a more narrow elevation beam width where the vast majority of clients (referred to as user equipment or “UEs”) are located, as mentioned above. In one embodiment the elevation beam width is +/−11.25 degrees relative to a horizontal axis, which can comprise a horizon of the Earth in a given location where the device is installed. These and other advantages of the present disclosure are described in greater detail with reference to the collective drawings.

As mentioned above, the multi-band antenna array device 100 can comprise a downtilt circuit that, in some embodiments, comprises a switched capacitor filter 160 that is capable of inducing any of a phase shift and phase delay, which are selectable by the user.

The multi-band antenna array device 100 also comprises a cooling assembly 130 that comprises a cylindrical heat sink that comprises a plurality of fins that provide efficient heat transfer to the ambient surroundings. In some embodiments, the cooling assembly 130 is configured to couple with a mounting pole, such as the mounting pole 101 (see FIG. 1). Cooling assemblies can be placed on either terminal end of the housing.

Also, the multi-band antenna array device 100 can comprise a lighting ring 132 that is disposed around a lower portion of the antenna arrays and above the cooling assembly 130. The lighting ring 132 illuminates when the multi-band antenna array device 100 is active. The lighting ring 132 can illuminate with different colors depending on the operational status of the multi-band antenna array device 100.

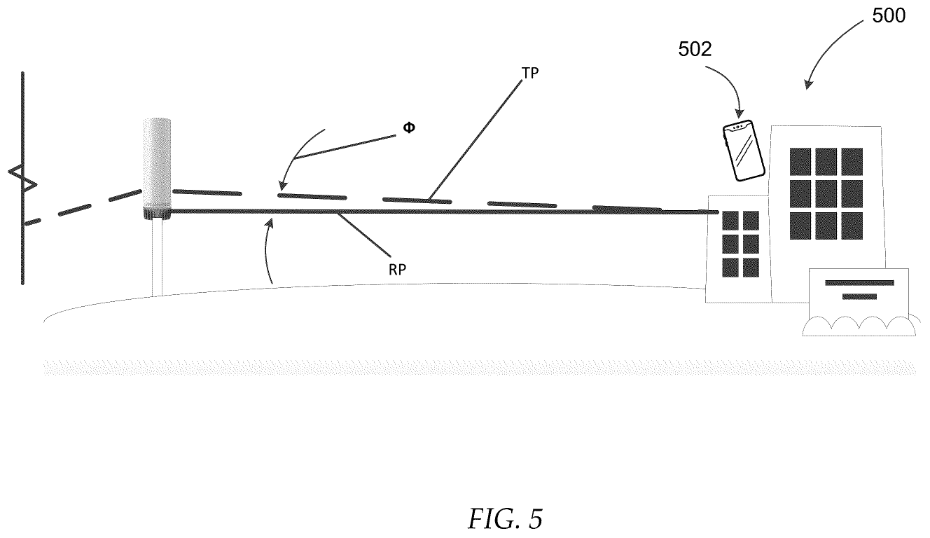

FIG. 5 illustrates an example use case of the present disclosure. A multi-band antenna array device 100 is located in a broadcast area 500. The broadcast area 500 comprises a plurality of UE devices 502. The broadcast area 500 can comprise a city, a portion of a city, or other geographical area where wireless services are deployed. The multi-band antenna array device 100 broadcasts in a substantially 360 degree pattern although only a portion of the broadcast pattern is illustrated in the side elevation view of FIG. 5. In one embodiment a target broadcast elevation for the multi-band antenna array device 100 is defined relative to a substantially horizontal reference plane RP, which is approximately zero degrees. The substantially horizontal reference plane RP is defined relative to a horizon of the Earth local to the multi-band antenna array device_100 and its broadcast area 500.

The multi-band antenna array device 100 can be positioned in any desired location within (or away from) the broadcast area 500.

With multiple arrays on a tubular surface as with the multi-band antenna array device 100 it is difficult to mechanically tilt an array toward users at ground level, because this would tilt the arrays up on the opposite side.

To beam from or direct the multi-band antenna array device 100 at a given angle, the multi-band antenna array device 100 can incorporate aspects of an electrical downtilt, so that an access point mounted in a high place can have gain tilted toward the ground.

In one embodiment, the electrical downtilt is fixed in its angular orientation relative to a reference plane. For example, a processor can introduce or cause a staggering of timing of alignment of elements through a corporate feed as described above. Antenna gain is maximized while the electrical downtilt can be set, for example, at two degrees relative to a reference plane that is zero degrees. This is merely an example, and the electrical downtilt can be any desired angle. In some instances the tilt can include an uptilt rather than a downtilt.

As mentioned above, the multi-band antenna array device 100 can include a means for dynamic or selective adjustment of downtilt angle by using a downtilt circuit. An example of a suitable circuit includes a switched capacitor that induces any of a phase shift and phase delay, which are selectable by the user.

Thus, in FIG. 5, a transceive plane TP is illustrated that has an electrical downtilt angle Φ of approximately two degrees relative to the reference plane RP.

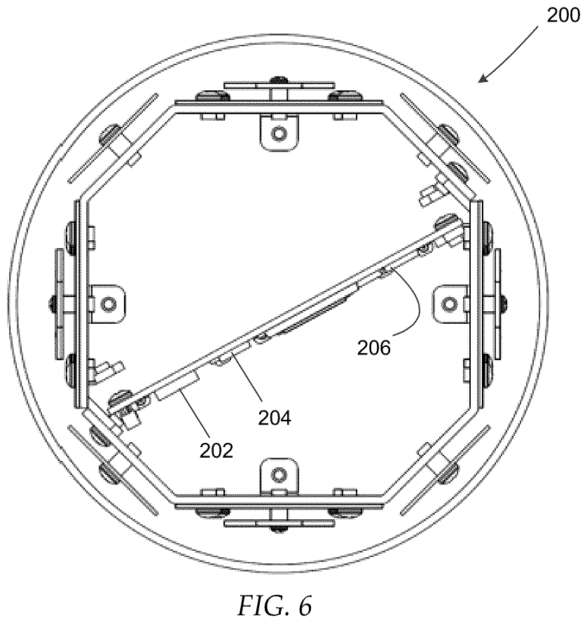

FIG. 6 illustrates another example multi-band antenna array device 200 that comprises a first radio 202, a second radio 204, and a third radio 206. In one embodiment the first radio 202 operates on a 2.4 GHz band. The second radio 204 operates on an upper portion of the 5 GHz band, and the third radio 206 operates on a lower portion of the 5 GHz band.

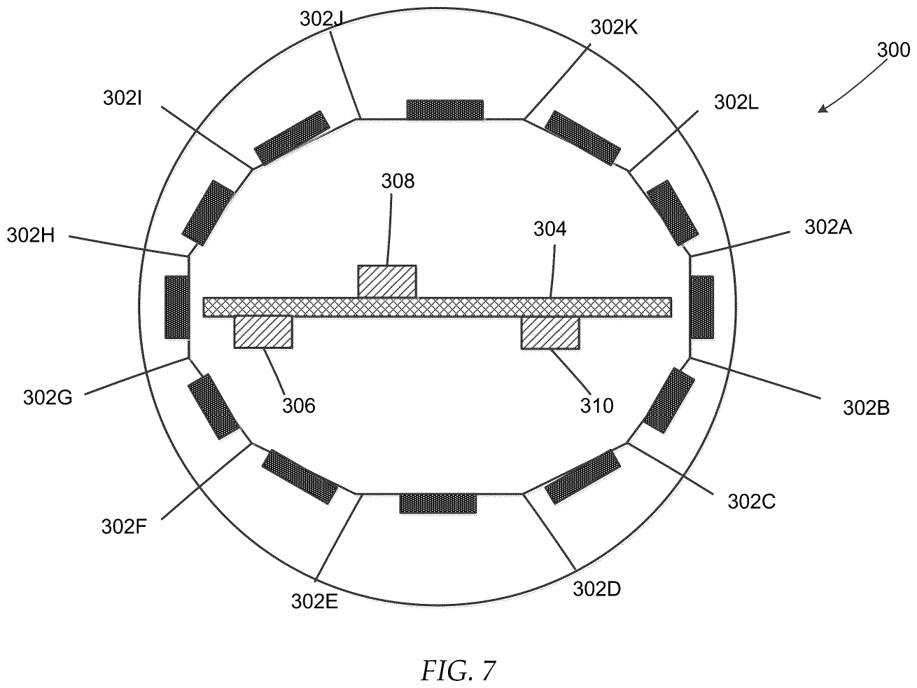

FIG. 7 illustrates another example multi-band antenna array device 300 that comprises a dodecagon grouping of ground plane substrates 302A-L, each comprising antenna elements. The device 300 also comprises a radio board 304 that comprises three radios. A first radio 306 operates on a 2.4 GHz band. A second radio 308 operates on a 5 GHz band. A third radio 310 operates on the 3.5 GHz band. In one embodiment the ground plane substrates 302A-L are arranged in an alternating pattern such that ground plane substrate 302A is coupled with the first radio 306, ground plane substrate 302B is coupled with the second radio 308, and ground plane substrate 302C is coupled with the third radio 310, and so forth.

Some embodiments above have disclosed a cylindrical shaped housing that encloses geometrically arranged substrates that receive antenna elements. These geometrically arranged substrates have been illustrated as being substantially vertical or perpendicular to a ground plane. Other embodiments allow for conical arrangements of geometrically arranged substrates where the substrates angle upwardly, or in other embodiments angle downwardly. A downward angled conical shape would allow for the device to transceive signals downwardly without requiring electrical downtilt. An upwardly angled conical shape would allow for the device to transceive signals upwardly requiring electrical uptilt, although some degree of tilt can be used in these embodiments as well if the physical shape is not enough to produce a desired angle of operation. Other geometrical configurations are likewise contemplated.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

While various embodiments have been described above, it should be understood they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A multi-band antenna array, comprising:
a tubular body comprised of a plurality of ground plane substrates which have been arranged into a geometrical configuration;
antenna arrays associated with the plurality of ground plane substrates, antenna elements of the antenna arrays being arrayed together in-phase so that an electrical downtilt of an elevation beam-width is fixed relative to a substantially horizontal reference plane; and
two or more radios connected to the antenna arrays on the plurality of ground plane substrates via a feed network.

2. The multi-band antenna array according to claim 1, wherein the electrical downtilt is selectively adjustable using a downtilt circuit.

3. The multi-band antenna array according to claim 2, wherein the downtilt circuit comprises a switched capacitor filter that induces any of a phase shift and phase delay, which are selectable.

4. The multi-band antenna array according to claim 1, wherein the two or more radios comprise a first radio that operates on a 2.4 GHz band and a second radio that operates on a 5 GHz band.

5. The multi-band antenna array according to claim 1, wherein the two or more radios comprise a first radio that operates on a 2.4 GHz band and a second radio that operates on a 3.5 GHz band.

6. The multi-band antenna array according to claim 1, further comprising a cylindrical housing that surrounds the antenna arrays.

7. The multi-band antenna array according to claim 1, further comprising a chassis, wherein the antenna arrays are mounted onto the chassis.

8. The multi-band antenna array according to claim 7, further comprising a radio board that comprises the at least one radio, the radio board being disposed inside the chassis.

9. The multi-band antenna array according to claim 1, further comprising a lighting ring coupled with a housing, the lighting ring displaying activated when the multi-band antenna array is functioning.

10. The multi-band antenna array according to claim 1, wherein the two or more radios comprises a first radio that operates on a 2.4 GHz band, a second radio that operates on an upper portion of a 5 GHz band, and a third radio that operates on a lower portion of the 5 GHz band.

11. The multi-band antenna array according to claim 1, wherein the geometric configuration comprises vertical surfaces.

12. The multi-band antenna array according to claim 11, wherein the vertical surfaces comprise 5 GHz antenna arrays and 2.4 GHz antenna arrays, the 2.4 GHz antenna arrays being placed in alternating fashion between the 5 GHz antenna arrays.

13. The multi-band antenna array according to claim 11, wherein the vertical surfaces are each associated with one of the plurality of ground plane substrates.

14. The multi-band antenna array according to claim 1, wherein the antenna elements of the antenna arrays are arrayed through the feed network in such a way that antenna gain is increased while elevation beam-width is reduced.

15. The multi-band antenna array according to claim 1, wherein each pair of adjacent antenna elements in the antenna arrays have an element-to-element spacing equal to a portion of a wavelength, the portion of the wavelength being 0.7 to 0.85 of a wavelength matching an operating band frequency.

16. The multi-band antenna array according to claim 15, wherein a portion of the antenna arrays include a 5 GHz antenna array, and where an elevation beam-width of the 5 GHz antenna array is within +/−5 degrees relative to a reference plane that is zero degrees.

17. The multi-band antenna array according to claim 1, wherein a corporate feed portion of the feed network comprises a fixed network of interconnect configured for eliminating a phase misalignment over frequency.

18. The multi-band antenna array according to claim 1, wherein at least one substrate of the plurality of ground plane substrates of the multi-band antenna array is configured in a downward angled conical shape.

19. The multi-band antenna array according to claim 1, further comprising a cylindrical housing that surrounds the antenna arrays and a lighting ring coupled with the cylindrical housing, the lighting ring displaying activated when the multi-band antenna array is functioning.

20. A method of configuring a multi-band antenna array in-phase, comprising:
arranging vertical surfaces in a geometric configuration, each of the vertical surfaces comprising antenna arrays aligned along the vertical surfaces, wherein antenna elements of the antenna arrays are arrayed together in-phase so that an electrical downtilt of an elevation beam-width is fixed relative to a substantially horizontal reference plane; and
connecting two or more radios to the antenna arrays on the vertical surfaces via a feed network, the vertical surfaces comprising 5 GHz antenna arrays and 2.4 GHz antenna arrays, the 2.4 GHz antenna arrays being placed in alternating fashion between the 5 GHz antenna arrays.
